(19) United States
(12) Patent Application Publication
(10) Pub. No.: US 2011/0098993 A1
(43) Pub. Date: Apr. 28, 2011

(54) METHODS AND SYSTEMS FOR IDENTIFYING MOLECULES OR PROCESSES OF BIOLOGICAL INTEREST BY USING KNOWLEDGE DISCOVERY IN BIOLOGICAL DATA

(75) Inventors: Jose Manuel Mas Benavente, Barcelona (ES); Albert Pujol Torras, Barcelona (ES); Patrick Aloy Calaf, Barcelona (ES); Judith Farrés, Girona (ES)

(73) Assignee: ANAXOMICS BIOTECH SL.

(21) Appl. No.: 12/912,535

(22) Filed: Oct. 26, 2010

Related U.S. Application Data
(60) Provisional application No. 61/255,299, filed on Oct. 27, 2009.

(51) Int. Cl. G06G 7/60; G06F 17/10

(52) U.S. Cl. 703/2; 703/11

(57) ABSTRACT

The present application relates to methods and systems of identifying molecules or processes of biological interest by using knowledge discovery in biological data. In particular, the present application describes new methods of creating a biological map, new methods of codifying such map, new methods of analyzing such map and new methods of identifying molecules and processes of biological interest. The present application provides methods and systems to identify new and useful direct or indirect therapeutic targets, molecular modulators, adverse events effectors, disease biomarkers, genetic biomarkers, safety-related biomarkers, diagnostic molecules, hormones, metabolites, or metabolic effectors of any type.

### CROSS-REFERENCE TO RELATED APPLICATION

The present application claims priority under 35 U.S.C. §119(e) to U.S. Provisional Patent Application No. 61/255,299 filed on Oct. 27, 2009, which is herein incorporated by reference in its entirety.

### TECHNICAL FIELD

The present application relates to methods and systems for identifying molecules or processes of biological interest by using knowledge discovery in biological data. In particular, the present application defines new mathematical methods, computational strategies and biological data processes to describe and analyze biological systems. The method of the present application allows the identification of molecules and/or processes of biological interest that can be of application to fields related to biology, medicine, health, biotechnology, pharmacology or environment.

### BACKGROUND OF THE INVENTION

Biological systems are complex in nature, and usually their external observable behaviour cannot be predicted from the analysis of their simplest components. Only those simplest living systems such as some virus or bacteria can be really fully understood and their behaviour predicted, but only when they are analyzed as isolated systems. One of the main objectives of scientific community is to compile all possible information about every biological and biochemical process, their components and associated molecules. This effort reaches its culmination with genome sequencing of organisms, and especially whit the human genome project. (Levy S, Sutton G, Ng P C, et al., The diploid genome sequence of an individual human, PLoS Biol., 5 (10), e254 (2007)). However, DNA information alone cannot explain by itself the observable behaviour of a superior organism. Stored data generated during decades by the scientific community contains an enormous amount of information about complex systems. Today, however, there are no methods or systems that can manage and analyze this information as a whole, and establish all the different functional interdependencies between the different levels of analysis (community, organism, system, cell, or molecule). Besides, the accumulated data may contain errors, missing data, or inconsistencies. Moreover, this difficulty is increased because the biological data has been usually captured at one specific time point, whereas time and external environmental factors influence the values of the biological observations. All these factors together define a complex working environment that very often cannot be studied by using the classical biosciences protocols.

In recent years, Systems Biology, a new area of knowledge in bioscience, has been developed to deal with this kind of information from a global perspective, and with the goal of being able to explain the observable behavior of living organisms from its smaller components (Kitano H, Systems Biology: a brief overview, Science, 295, 1662-63 (2002)). This new strategy has been mainly focused to describe the relationships between biological components; for instance: the physical relationship between proteins that define the Interactome (Ewing, R. M. et al., Large-scale mapping of human protein-protein interactions by mass spectrometry, Mol. Syst. Biol. 3, 89 (2007)), or the ensemble of metabolic relationships between proteins that define the human metabolome (Wishart, D. S. et al., HMDB: the human metabolome database, Nucleic Acids Res. 35, D521-D526 (2007)). The analysis of interactome and metabolome are being employed as valid strategies to explain cell behaviors, and it is useful for monitoring how they coordinately change in response to a particular stimulus such as the onset of a disease. Both, interactome and metabolome, use genetic information from the organism, but also data related with protein expression obtained from microarrays, comprehensive measurements by using monoclonal antibodies against specific proteins, metabolite measurements, and a number of other data sources describing the status of an organism in a given status.

Pharmacological sciences have gone through an analogous course, with traditional approaches being mostly reduced to the study, at molecular level, of the target-compound duet. However, phenotypic observations (i.e. disease symptoms) are often the result of an incredibly complex combination of molecular events. This is because virtually every major biological process is not carried out by a single molecule but by large macromolecular assemblies and is often regulated through a complex network of transient interactions. Moreover, since most pathways are interconnected, slight changes in these transient regulatory networks can trigger a variety of processes, with remarkably different results.

In the last years, several efforts have been oriented to model biological processes by network analysis (e.g., NetworkBLAST (Sharan and Ideker, Modeling cellular machinery through biological network comparison, Nat. Biotechnol. 24,427-433 (2006)). Existing programs suffer from certain limitations, such as a fixed assignment of orthologs or no support for intra-species comparison, which prohibits the detection of alternative pathways, and prevents the identification of backup circuits and cross-talk between pathways of the same species. Furthermore, some programs are based only on an empirical scoring scheme and not backed-up by a probabilistic model, or they are tailored towards detecting conserved complexes and less effective at identifying pathways of arbitrary topology to generate a comprehensive molecular description of a given pathology, including the system's responses to drug application, several different states of the system need to be compared (e.g., diseased vs. healthy, or drug-perturbed vs. drug-unperturbed), for instance by deriving the so-called System Response Profiles (SRPs) (Van der Greef et al., Innovation rescuing drug discovery: in vivo systems pathology and systems pharmacology, Nat. Rev. Drug Discov. 4, 961-967 (2005)).

Today, the attrition rate of drugs in development, i.e., the number of drugs that fall during the clinical development (studies in real patients) due to lack of efficacy or poor safety, is increasing, and this problem is having undesired consequences for the pharmaceutical industry that see their revenues decrease because of the stagnant innovation and the lack of new effective and safe drugs, and for patients, that still suffer many unsolved health problems (Wood, A Proposal for Radical Changes in the Drug-Approval Process, N Engl J Med. 355, 6, 18-23 (2006)).

To increase the revenues of drug discovery and to help solve patient's health problems, therefore, it is necessary to improve our knowledge of the molecular mechanisms of disease, consider the full biological context of a drug target and move beyond individual genes and proteins. A deeper understanding of the molecular mechanisms beneath a disease phenotype will finally permit the discovery of new potential drug targets, suggest more effective combinations of products already on the market, help select the best-suited model organisms to study a pathological pathway, or identify disease-specific biomarkers.

There is a number of patents and patent applications dealing with certain limited aspects of the use of systems biology or mathematical modeling to solve some biological issues. For example, U.S. Pat. No. 6,539,347 B1, the disclosure of which are all incorporated by reference herein, refers to a method of generating a display for a dynamic simulation model utilizing node and link representations. The simulation model includes a number of objects which include state, function, link and modifier objects. The present application can be applied to biological data according to the authors, although the authors do not provide means for analyzing the biological sense of the data displayed.

US Patent Application Publication No. 2007/0038385 to Tatiana Nikolskaya et al, the disclosure of which are all incorporated by reference herein, provides methods for identification of novel protein drug targets and biomarkers utilizing functional networks. The authors provide a process of “System Reconstruction” to integrate sequence data, clinical data, experimental data and literature into functional models of disease pathways. The goal of the authors is to claim a process of elucidating specific mechanisms of action and biological pathways by finding the interconnections between elements. Authors do not provide mathematical modeling strategies of general applicability by which different predictions can be systematically inferred from the map.

U.S. Pat. No. 6,873,914 B2 to Icoria, Inc., NC, the disclosure of which are all incorporated by reference herein, provide methods and systems for analyzing complex biological systems. The authors provide methods to organize complex and disparate data, mainly biological data, arising from many different experimental sources, in coherent data sets, and then using those data sets as models for biological systems. The authors do not claim methods, systems or strategies of general applicability by which different predictions can be systematically inferred from the map.

The present application solves many of the limitations described in prior art, by providing new methods of analysis that have proven to be useful in several examples.

### SUMMARY OF THE INVENTION

The present application provides novel methods and systems that are directed to identifying molecules or processes of biological interest by using knowledge discovery in biological data.

The methods and systems of the present application comprise the principal steps of (1) creating a Map of Biological Elements that defines the System, (2) Developing Mathematical Models, and in some cases, (3) Performing Experimental Validation of the Mathematical Models, in order to obtain a desired result. In all three steps of the method, Biological Data or Biological Information in its different forms is used to create, construct, complete, model, validate, refine and check the models and the desired results.

The present application provides novel methods for identifying molecules of biological interest such as, but not limited to, direct or indirect therapeutic targets and the molecules that modulate their behavior, direct or indirect adverse events, effectors of detectable phenotypes, disease biomarkers, genetic biomarkers, safety-related biomarkers, diagnostic molecules, hormones, metabolites of any type, and the similar, and for identifying the processes of biological interest and their components such as, but not limited to, any biological process occurring inside the human or animal body that can lead to a disease cure, that can be related with a drug safety related process, that can be related with a biomarker process, that can be related to a diagnostic process, that can be related to the knowledge of a biological mechanism of action and similar processes.

One of the steps of the present application includes the step of Creating a Map that defines the System to be analyzed and that includes all relationships between biological elements in the nature. This process could imply establishing relationships between elements even when the relationship between them is not known yet, or to predict the existence of a not yet known element and its relationships with the rest of elements of the map.

One of the steps of the present application comprises the definition of node and link in the most abstract level that the user can conceive. Any type of molecule or process or group of molecules or processes can be considered as a node in the System (for instance: a protein, a metabolite, a gene or a protein pathway). Any type of relationship between nodes can be considered as a link, being preferably defined by a combination of metabolic, physical interaction and signaling relationships between two nodes.

In another aspect, the present application can provide the definition of the System in terms of a Map. This Map contains all nodes and links, previously known or unknown, and the relationships between each other.

One of the steps of the present application comprises methods to assign novel properties, functions and roles to certain previously known or unknown nodes or links, arising from the analysis of the map.

One of the steps of the present application provides databases identified as True-Tables that contain known information about the System as Input and Output signals. Input signals can be extrinsic (drug inhibition effects, for instance) or intrinsic (knowledge about the phenotype effect derived from gene alterations). Output signals are given by measurable effects in terms of physiological effect, for instance derived from adverse events or from indications of drugs.

One of the steps of the present application provides methods by which nodes and links are defined as mathematical functions. In consequence, according to the present application, any known biological activity can be translated as Input or Output over the Map and True-Tables contain all known the definition of Inputs and Outputs signals.

One of the steps of the present application not identified in the prior art allows the end user to use mathematical transformations with a reduction of dimension of System to further analysis. A preferred embodiment of the present application is to use those transformations that allow reaching 2 or 3 dimensions, allowing the representation of the System in a screen or a paper of the system.

One of the steps of the present application provides novel methods not described in prior art by which functions and their parameters associated with nodes and links are estimated by means of artificial intelligence strategies. In a preferred embodiment genetic algorithms or any associated or related strategy are used.

One of the steps of the present application provides novel methods not described in prior art by which all functions associated with nodes and links define the final Mathematical Model of the System, step 2. In a preferred embodiment a pool of mathematical models are used to describe the System and to explain the True-Table.

In yet another aspect, the present application provides a Mathematical Model capable to explain the True-Tables, or in other terms, to reproduce and to explain known biological information about the System. Both, the System or the Map and the Mathematical Model can be represented by a final report or by mathematic algorithms materialized by means of one or more computer programs, being those deliverables and their direct and indirect conclusions the final result of the execution of the present application. A set of nodes or links will be identified as interesting for any biotechnological or biomedical application. So their corresponding real elements will be putative interesting elements with commercial use such are proteins, genes, molecules, relationships between them or new elements or relationships to be discovered for all those described use: drug targets, safety, biomarkers, biotechnology applications, etc.

One of the steps of the present application provides mathematical methods useful to discover new target nodes of pharmaceutical or medical interest. These methods are applied to discover target proteins or genes useful to develop new drugs, to conduct safety analysis, predict adverse events or any other activity regarding drug discovery; or in other areas of activity to develop diagnostic kits (for instance for health care or environment area); or in other areas of activity to develop new capabilities or to develop new ones for a bacteria or other organism for any biotechnological approaches.

One of the steps of the present application provides novel methods that, instead of having a simply Target node for any use, provides a strategy to discover more than one node that produces the effect under study. In the drug discovery process, for instance, the method provides a way to reduce the activities of the drugs because if more than a target exists, the concentration of a specific drug can be lower, thus decreasing both the toxicity and functional activity. However, the decreasing of functional activity can be supplied developing new drugs against other targets but with the same functional activity, thus having a synergistic effect. In a kit design, the methods provided will allow to identify simultaneously several markers at the same time, increasing the usefulness of the kit due to the synergistic effect of the combination.

One of the steps of the present application provides methods that allow determining the mechanism of action of a given biological process. Typically, the human biological processes are complex enough to be unknown in complete detail. The present application allows the end user to understand globally the system even when a particular analysis is not feasible.

In one aspect, a method for identifying a new use for a known therapy is provided, by applying the methods described herein.

In another aspect, a method to prioritize molecule candidates for further drug development is provided, by applying the methods described herein.

In another aspect, the present application comprises a method of conducting business that comprises receiving compensation from a customer in return for identifying to the customer any biological element or any biological process of interest for the costumer by using the methods and systems of the present application as described herein. The definition of the service according to the present application is named “Therapeutic Performance Mapping System”, and may include different combinations of aspects related to discovery, efficacy, safety, sensitivity, and the similar.

In another aspect, the present application provides at least one computer-readable medium and at least one processor system coupled to such computer-readable medium, and at least one output human-readable system coupled to the previous elements, being the whole system capable of executing the systems and methods of the present application in a specified manner, comprising a database module capable of creating and storing databases of biological data, a first unit operations module, capable of transforming such databases into biological maps, a second unit operations module, capable of generating at least one mathematical model, an analysis module capable of executing experimental analysis and processes as described herein, and a comparison module capable of comparing results arising from the models to at least a first set of empirical data.

Additional objects and advantages of the application will be set forth in part in the description which follows, and in part will be obvious from the description, or may be learned by practice of the present application. The objects and advantages of the present application will be realized and attained by means of the elements and combinations particularly pointed out in the appended claims.

It is to be understood that both the foregoing general description and the following detailed description are exemplary and explanatory only and are not restrictive of the present application, as claimed.

### BRIEF DESCRIPTION OF THE DRAWINGS

The accompanying drawings, which are incorporated in and constitute a part of this specification, illustrate several embodiments of the present application and together with the description, serve to explain the principles of the present application. The accompanying drawings are not intended to be drawn to scale.

FIG. 1 is a conceptual representation of the system of analysis, including the Biological Elements (nodes) and the Biological Relationships (links).

FIG. 2 is a description of the general methods and systems of the present application. The methods and systems of the present application comprise the principal steps of (1) Creating a Map, (2) Developing Mathematical Models, and (3) Performing Experimental Checking with the Mathematical Models, in order to obtain a desired result. In all three steps of the method, Biological Data or Biological Information in its different forms is used to create, construct, complete, validate, refine and check the models.

FIG. 3 is a detailed description of the principal step (1) Creating a Map. This step includes the substeps of identifying Seed node, Adding related nodes, Linking nodes, Adding artificial nodes, Adding artificial Links, Aggregation of nodes, Pruning nodes and obtaining as an end result the Map of nodes and links. The process is iterative. In all the steps of the method, Biological Data or Biological Information in its different forms is used to create, construct, complete, validate, refine and check the models.

FIG. 4 is a detailed description of the principal step (2) Mathematical models. Starting from the Map of nodes obtained in step (1), a Mathematical model is applied to the map, the model is parametrized and the model is validated. If the model is correct according to biological information, next step is followed. The process is iterative until the best model that explains the biological information is found.

FIG. 5 is a detailed description of the principal step (3) Experimental checking. From the Mathematical models, the system is perturbed, and a set of information is inferred. Thus the user of the present application checks if the inferred information explains the available biological information. The process is iterative until the inferred information is in line with the available biological information.

FIG. 6 shows an example of True-Tables structure. The True-Tables include the set of inputs and output signals corresponding to known effects of mainly main drugs. Each ID_TRUE can be associated to some inputs and/or outputs. Usually the inputs corresponding to genes or proteins and the signals are measured in normalized values in rank (0-100).

FIG. 7 shows (left) a transformation of the map by means of Principal Component Analysis, and identification of a node cluster of interest (arrow), and (right) Multidimensional Scaling (Sammon's Method) approach and identification of a node cluster of interest (arrow).

FIG. 8 shows a process by which a perturbation propagates its effect over the map. Black areas are areas where the proteic function of underlying proteins is activated, and dotted areas are areas where the proteic function of underlying proteins is inhibited.

FIG. 9 is a graph showing the new therapeutic indications of Diazepam as discovered by using the methods of the present application. X-axis shows the Hausdorff's distances between the effectors of each indication and the seed nodes, i.e., the protein targets of Diazepam. The Y-axis shows the percentage of specificity (accuracy) of the prediction for each point. The point marked is a new therapeutic indication for the compound identified by the methods herein with a predicted 100% specificity.

FIG. 10 is a graph showing all described adverse events for Diazepam, and identifying other potential adverse events not previously described (marked points), with a predicted specificity of 100%.

FIG. 11 is a graph showing the effects of AX_ALZ_{—}004 on amyloid pathology. AX_ALZ_{—}004 significantly increases β-amyloid Aβ₁₋₄₂, the more fibrillogenic form of Aβ, and reduces Aβ₁₋₄₀/Aβ₁₋₄₂ ratio. Data are mean±SEM values of 4 independent experiments (* p<0.05, ** p<0.01, *** p<0.001).

### DETAILED DESCRIPTION OF THE INVENTION

Reference will now be made in detail to the present embodiments (exemplary embodiments) of the present application, an example(s) of which is (are) illustrated in the accompanying drawings. Wherever possible, the same reference numbers will be used throughout the drawings to refer to the same or like parts.

Definitions

For clarity and consistency, the following definitions will be used throughout this application. To the extent that the following definitions conflict with other definitions for the defined terms, the following definitions will control.

As used herein, the terms “Biological data” and “Biological information” mean a set of data which is constituted of biological elements and of the relationships between them.

“Biological element” refers to any type of molecule existing in the human or animal body or bacteria or virus such as proteins, polypeptides, polynucleotides of any type, hormones of any type, genes, metabolites, signaling molecules, amino acids, neurotransmitters, and the similar, alone or in any combination.

“Biological Function(s)” means measurable biological activity that usually produces physiological effects. It can be done by a single node or by undetermined number of them that, by definition, can be grouped by means of some patterns or criteria.

“Knowledge Discovery” refers to methods for identifying elements, processes and results of interest by analyzing by a plurality of mathematical methods sets of data of diverse degrees of complexity.

“Effector” refers to: This is a node or a group of nodes which activity can be measured in the nature as a phenotype. For instance in health those Biological elements that are directly related with a pathology.

“Input Signal” refers to any signal that is originated from any knowledge source and which is applied over the map that implies the activation or inhibition of a node or a group of nodes.

“Link” represents a union between two nodes that can be materialized as mathematical function that describes the relationship between nodes.

“Node” represents a Biological Element that can be materialized as mathematical function.

“Molecules of biological value or biological interest” refers to any molecule or biological element as above defined, selected alone or in any combination from the group composed of: direct or indirect therapeutic targets, direct or indirect adverse events effectors, disease biomarkers, genetic biomarkers, safety-related biomarkers, diagnostic molecules, hormones, metabolites, metabolic effectors or modulators of any type of the above elements, and the similar.

“Direct link” or “direct relationship” refers to a direct contact or effect of one node over another node

“Indirect link” or “indirect relationship” refers to a contact or effect of one node A over another node B which is produced or mediated via an intermediate node or nodes existing between A and B, so A and B are not in direct contact.

“Output Signal” refers to any signal produced in the perturbation process to the undetermined number of nodes (Effectors) that produces measurable physiological effects.

“Perturbation” refers to the transmission of any Input Signal given to Target Nodes toward the Effectors through the Map.

“Processes of biological value or biological interest” refer to any biological process occurring inside the human or animal body that can lead to a disease cure, that can be related with a drug safety related process, that can be related with a biomarker process, that can be related to a diagnostic process, that can be related to the knowledge of a biological mechanism of action, and the similar.

“Seed Nodes” refer to those biological elements that are the origin of the

Map.

“Target Nodes” refer to nodes that are the hole of a Input Signal.

“True-Tables” refer to tables or databases containing data where nature has been parameterized in a vector way. It contains: a) vectors of cause-effect data and, b) information according to nature. For instance, in a) the targets of a drug are useful to treat a specific pathology, and b) a gene is essential for life.

“Global” refers to the application of methodologies and techniques to solve different problems embracing different situations (for example, different diseases) in a systematic and generalized way.

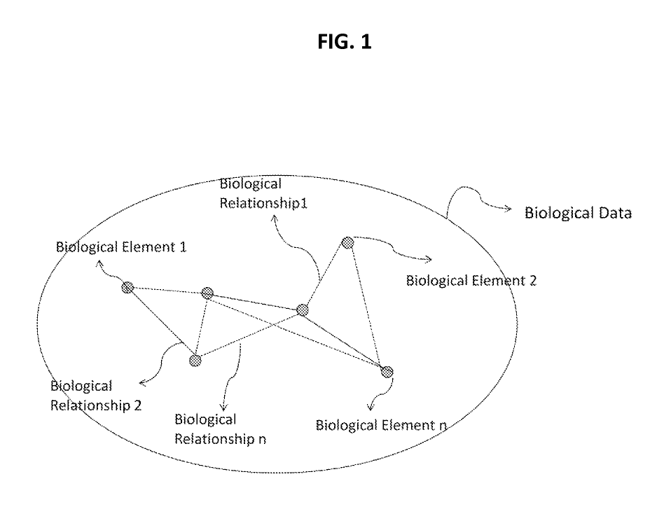

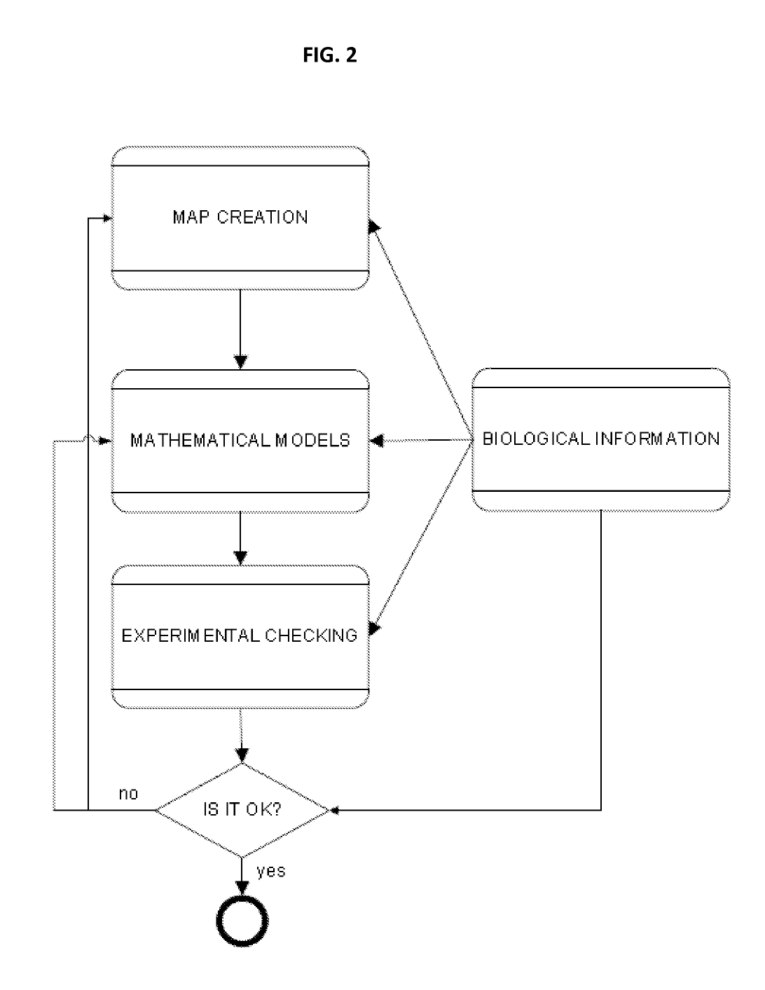

The methods of the present application comprise the principal steps of (1) Creating a Map, that defines the System (2) Developing Mathematical Models, and in some cases (3) Performing Experimental Validation of the Mathematical Models, in order to obtain a desired result. In all three steps of the method, Biological Data or Biological Information in its different forms is used to create, construct, complete, validate, refine and check the models (FIG. 1). FIG. 2 details the principal methods and systems of the present application.

Step 1: Creating the Map and Defining the System of Analysis

Description of Nodes, Links and Systems

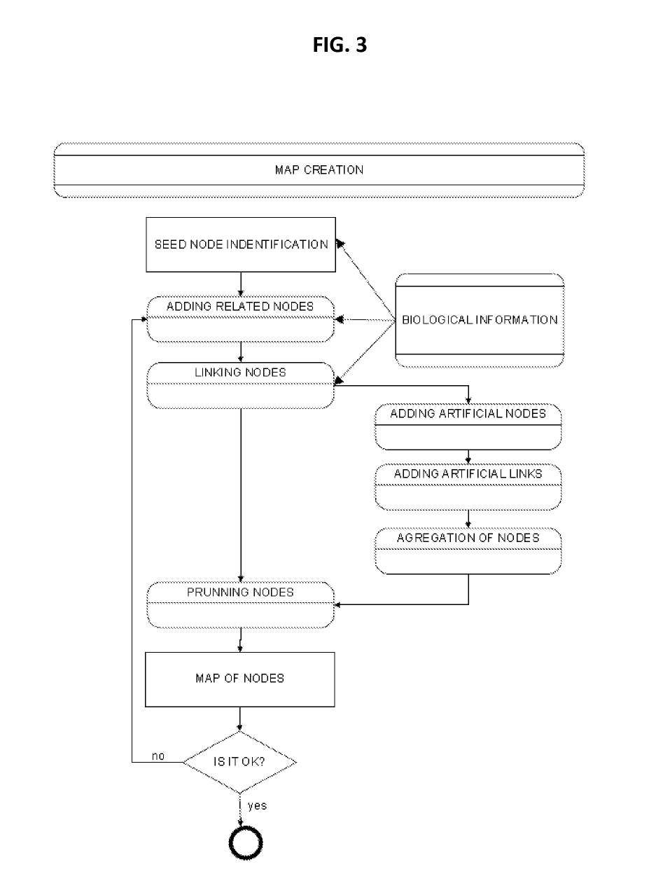

In a first step of the present application, the process includes creating a map or a graph or a scheme of the relationship between biological elements. Each biological element will be represented by a node. The relationship between nodes will be described by a link. In a preferred embodiment a graph structure of n Dimensions is created, being n a natural number. The process of creating a map is depicted in FIG. 3.

The total set of nodes and links defines the System of analysis.

In a preferred embodiment, the System is defined as a database containing nodes and links and their existing relationship with biological elements. This database will warrant the possibility to store nodes and links even when they are not yet known.

The nodes can be any naturally occurring biological element, specially proteins, polypeptides, polynucleotides of any type, hormones of any type, genes, metabolites, signaling molecules, amino acids, neurotransmitters, and the similar, alone or in any combination in any proportion or groups of them. In a preferred embodiment, the system is composed of proteins, genes and metabolites.

Nodes can represent known elements or unknown elements, predicted by the method of the present application.

The type of relations between nodes is selected from, but not limited to, the group comprising metabolic pathways, physic relationships, signaling pathways, protein expression, functional activity, definitions, locations or any other definition by means of which a given node can be related with any other node.

Usually the information about relationships between nodes is stored in public or private databases such as STRING (von Mering et al., STRING: known and predicted protein-protein associations, integrated and transferred across organisms. Nucleic Acids Res., 1(33), D433-D437 (2005)), INTACT (Kerrien et al., IntAct—Open Source Resource for Molecular Interaction Data, Nucleic Acids Research (2006), doi: 10.1093/nar/gkl958), or REACTOME (http://wiki.reactome.org). Also, this information is stored in scientific literature, and can be extracted by means of text mining, microarrays analysis or by any other method of measuring a biological status of an organism.

One of the steps of the present application comprises the definition of node and link in the most abstract level that the user can conceive. Any type of molecule or process or group of molecules or processes can be considered as a node in the System (for instance: a protein, a metabolite, a gene or a protein pathway). Any type of relationship between nodes can be considered as a link, being preferably defined by a combination of metabolic, physical interaction and signaling relationships between two nodes.

Description of the Map

There are a plurality of ways to create the Map of the System depending on the limitations of the computational availability.

The first strategy is not to limit the size of the system to be treated, having in this case a system with all available data in terms of nodes and links.

When there are computational limitations (for example in data storage or calculation speed), and according to a second strategy of the present application, the System must be defined by the analyst and the information included in the System will be limited by its content.

Limited Systems do not contain all the available information for nodes and links, so the System has a certain probability of losing information potentially useful. This information not taken into account in the System will be measured and evaluated. This strategy makes the system computationally manageable, and in consequence, available to be analyzed.

The present application provides novel methods that will allow the end user to obtain the desired result, and at the same time minimize the quantity of lost information. These methods are described here by means of seeding, integration, pruning and extension strategies.

Creating the Map from Seeding Nodes

According to the present application, the map is created starting from a certain group of selected nodes (seeding nodes or seed nodes). The seed nodes will be selected from prior art in scientific and biomedical knowledge related with the problem to be analyzed.

In a preferred embodiment, this is information is obtained from public and private databases that define drug activity and mechanism of action (for example, but not limited to, DrugBank (http://www.drugbank.ca), ADIS (Wolters Kluwer Pharma Solutions, http://www.wolterskluwer.com), or the similar) and biochemical information about the problem to be analyzed.

One of the steps of the present application and a preferred embodiment comprises the identification of those proteins that are related with the problem to be analyzed (e.g., pathologies, adverse events, etc).

In a preferred embodiment, each seed node can be visualized as one isolated graphic element in an infinite space of n dimensions.

Map Extension

The present application provides novel methods to allow the system to expand (map extension), with the following main objectives and restrictions:
1. To include all known available information in terms of nodes and links, to avoid the problem of losing information. The extension process must warrant the possibility to create links and nodes even when they do not exist, or even when they are not evidently arising from the existing sources.
2. To avoid having a System with unconnected nodes.
3. To have a System with the maximum size allowed by the analytical capabilities defined by the end user.
4. To make sure that the system includes all possible nodes and links that contain information useful for the objective of the analysis.

When the direct links between seed nodes are not possible a new node can be added to the system. This new node will be selected following the objective of not having isolated seed nodes. The nodes and links will be selected initially from the database of known nodes and links, but the growing and expansion process could require the creation of an unknown node or link. In any case, each element of the map (node or link) must keep its reference and the reason for which it has been included in the System.

In a preferred embodiment the extension of the system will be executed by means of an iterative method strategy to maximize the presence of elements of True-Tables in the System. Each new node candidate to be included in the system must be connected, at least, with one node belonged to the System. The iterative process could finalize when there is no seed node that remains unconnected and nodes present into True-Tables are in enough proportion to create the Mathematical Model of the System. The minimal number of nodes connecting seed nodes and including these seed nodes will be considered the backbone of the system.

In other preferred embodiment a spherical extension of the system will be performed from seed nodes, being the center of each sphere each node. Iterative processes of extension will be conducted until all seed nodes are connected.

One of the steps of the present application and a preferred embodiment comprises a method to allow the growing and expansion of the system by which priorities are set to maximize the quantity of available information, and at the same time to minimize the size of the system to analyze.

Map Pruning

In the process of growing and expanding the system, the number of nodes and links can exceed the analytical capabilities of the end user. In this case it will be necessary to proceed to prune (selectively reduce the size of) the System.

Codifying Biological Data

The System must be defined in biologically specific and consistent terms that are able to describe its constituents even when they are not known, that is, nodes and links must have their equivalent biological elements.

The methods of the present application allow identifying and/or assign global properties for regions of the map and to infer and to assign new properties or roles to nodes or links, arising from the global properties of the region where they are present, even when they are not known.

Assigning Biological Sense to Nodes, Links and Regions of the Map

According to the definitions of the present application, nodes in biological terms means a biological element, and links in biological terms means relationships between biological elements.

Each node, link or region of the Map has in first term its corresponding biological element. However, a node, link or region of the Map could be created de novo being suggested its existence in the process of Map creation, even when its corresponding biological element is previously unknown. The assignment of the biological roles, functions and properties to these nodes, links and regions of the Map will be assigned in the process of analysis.

In a preferred embodiment the information about functions, roles and properties of each node or link will be obtained from scientific prior art in any format: literature, databases, experimental data from microarrays, etc. However, new functions or roles could be identified during the process of Map construction or the Analysis of the System, establishing a new property or role for these nodes, links or regions of the Map.

These functions and roles for nodes, links or regions of the Map could be different in different conditions: location (species, tissue, cellular organelle, etc), environment (nodes or links around it, for instance). Properties of nodes, links and regions of the Map node may have in itself distinguishable states, such as different states of maturation or different forms, being some of them active or inactive. For instance, one protein (node) can be phosporylated or not phosporylated, thus arising to several different states within a given node.

Each node, link or region of the Map can belong to, or be present in, a specific location (Tissues, Cell types and Cell organelles) or can be present in all parts simultaneously of an individual or, having the same sense, they can be species-specific (be present in only one specie) or not (can be present in a plurality of species). The Analysis of the System may imply interferences between location of nodes, links and regions of the Map. For instance two or more species could have common proteins in both species, being this protein a point of union. Any effect over this protein will affect both organisms.

One of the steps of the present application provides novel methods and systems to assign new locations (e.g., in species, tissues, cell types, cell organelles, etc.) for a node, links or regions of the Map arising from the prior art of from the Map Analysis, even when nodes, links and regions of the Map are unknown.

Biological Inputs in the Map

According to the present application, a Biological Input is defined as any signal that is originated from any knowledge source and which is applied over the map that implies the activation or inhibition of a node or a group of nodes.

This signal will be evident to the end user of the present application by detecting the activation or inhibition produced in identified nodes (Targets or Effectors). The activation or inhibition of them will not produce necessarily per se any measurable effect over the Map (phenotypic effect). The input signal will be transported as a perturbation over the Map and it will move its consequences to other nodes, links or regions of the Map.

In a preferred embodiment this signal will be stored in True-Tables; for instance drug effects over biological systems, being identified the Target nodes and the type of signal (activating or inhibiting) about how this signal will affect each target node.

In another preferred embodiment the signal is produced by known intrinsic information of the system mutation, deletion or variation of a node, link or region of the Map that could be considered in the same sense as activation or inhibition over them. Mutations, deletions, translocations, splicing or any other biological process that DNA, RNA or proteins can suffer are examples of signals.

In a preferred embodiment the information of Biological Inputs will be obtained from databases and literature. For example, public or private databases including information about drug-to-target interactions, characteristics of drug targets, characteristics of drugs, signaling pathways databases, metabolomics databases, interactomics databases, databases containing clinical data of compounds in development or drugs already commercialized, and the similar. Literature includes public databases like Pubmed, and the similar.

Biological Outputs in the Map

According to the present application, a Biological Output will be defined as any signal that is originated from any knowledge source and which is applied over the Map that implies the activation or inhibition of a node or a group of nodes.

In terms of analysis any output signal will be considered as a reading of any perturbation over one or more nodes which have directly or indirectly known measurable effects over the individual.

In a preferred embodiment the information of Biological Outputs will be obtained as is explained from databases and literature and it will be stored in True-Tables. In a further preferred embodiment it is considered as especially important those information obtained from databases about health, drug effects (therapeutic indications and adverse events), physiology knowledge and general medical documentation and any other type of documentation that describe an effect or the functional way of any organism.

Measurable Physiological Effect Assignment and its Mathematical Understanding in the True-Tables

The Biological Output will generate directly or indirectly a measurable effect in an individual and it will be measured in the Physiological Effect Assignment. The Biological Output signal will be evident for the observer by the activation or inhibition produced in one or more nodes over which the activity (activation or inhibition) generates the measurable physiological effects. These nodes will be considered Effectors of the physiological effect which is being studied.

If it is possible, the Physiological Effect will be measured in terms of health in those species where it can be measured.

The process of Physiological Effect Assignment can be divided in two types of determinations: a) those physiological effects that affect the health status of the individual (improving or producing a deterioration); or b) altering the pattern of activation or inhibition of nodes (proteins or genes usually) without any measurable consequence in health status.

True-Tables store all Physiological Effects measured in terms of nodes, links and group of nodes and links that when altered in any sense (activation or inhibition) produce the alteration of a measurable Physiological Effect.

In a preferred embodiment this information is obtained from prior art, especially those data stored in databases being useful. However this information also can be inferred from previous analysis over data stored in True-Table. Examples of Physiological Effects stored in True-Tables are the health effect produced for a mutation of a gene, the effect of a known drug, or microarrays in controlled status (healthy patients, for instance).

True-Tables store Input and Output signals. For instance, some Input signals are drug targets and the store value in True-Tables is +1 when the drug produces an activation of the target and −1 when it produces the inhibition of the target; being the target a protein, a gene or a group of them. Examples of Output signals stored in True-Tables are the phenotypic effect that produces the activation (+1) or inhibition (−1) of a protein, gene or group of them. For instance, a deletion of a protein is stored as −1. Other examples are adverse events of drugs where all proteins and genes related in prior art with a health phenotype have been characterized and documented in True-Tables with their corresponding values of activation or inhibition.

The data stored in True-Tables is mainly obtained from prior art but also from inference of knowledge. We can define next main sources for the information:
a) Medical information, where physiological effects, drugs for instance, are catalogued in terms of probability as frequent, occasional or rare in reference to the information of some potential measurable effect caused by the activation or inhibition of any biological element. In a preferred embodiment this inference is obtained from prior art and databases.
b) Biochemical information, where the knowledge of scientific community about a biological element is also incorporated in True-Tables. In a preferred embodiment this information is obtained from metabolism knowledge, protein-protein interaction experiments, protein expression in microarrays or direct measures of identified proteins, gene documentation, etc. All this information is mostly stored in databases and it is transformed and stored in True-Tables.
c) By means of ontology analysis or other inference of data is possible to infer the existence, the properties, functions and roles of a node, links or group of them or their equivalent biological element. In a preferred embodiment any inference of information can be obtained from other Maps (obtained from other tissues, cell locations, species or whatever equivalent relationship between nodes), or from the environment of a node in the Map.

In a preferred embodiment the values of Input and Output signals that are emanating from each node to its neighbors by means of its links will be included in the interval [−1,1], being those values inhibition or activation over the basal state. The zero values represent the basal state of node in the map, being this node activated (values over 0) or inhibited (values under 0). Usually it means the healthy state or at least the most common state of health in the analyzed map. So, each link emanating from a node can have an effect of activation or inhibition over neighbor nodes conveying or influencing its state to neighbor nodes. This effect of each node is defined by two functions: the activation function and the output function.
In a preferred embodiment each node has its own activation function. This function usually generates a value inside the range [−1,1], being the function mainly a normalizable sigmoid, an hyperbolic tangent, a polynomial or any other function being continuous inside working range.
In a preferred embodiment the output function generates the value of output of the node by means of an equivalent function to the activation function.

In terms of analysis any Input signal will be considered as a perturbation over the energy of the Map, and this perturbation will be measured as an Output signal.

One of the steps of the present application provides systems and methods by which each node and links are defined as mathematical functions, and thus, the biological element represented by each node and the relationship between each other are considered mathematical functions.

Step 2: Mathematical Understanding of Biological Data and Models Creation

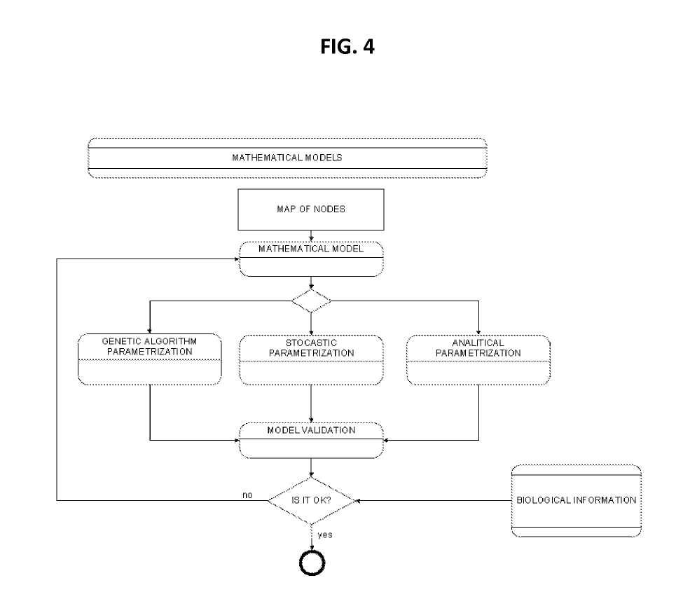

The present application provides novel methods to conduct a plurality of mathematical transformations over the map to obtain useful knowledge of physiological effects. It allows identifying regions on the map in terms of medical, biochemical or pharmacological properties that can be measurable in the nature. The steps of the method are depicted in FIG. 4.

The present application provides novel methods to infer from the mathematical model interesting biological information that can be further used for health (human and veterinary), food, and cosmetic applications, but also for related and more general fields like biochemistry, physiology, psychology, biology, medicine and the similar.

In a preferred embodiment, the present application provides novel methods for identifying molecules and processes of biological interest, for example, but not limited to, the following:
Target discovery or target selection methods discovering nodes whose activation or inhibition produces a physiological effect useful to prepare and conduct drug target discovery, drug repositioning, drug combination, adverse event prediction, identification of biomarkers for diagnostic kits and the similar.
Interesting molecules discovery, that is, identification of molecules that exert certain desired effect on the map, for example, modulating (activating or inhibiting, or a combination thereof) the activity of one or several targets.
Multifocal Targeting, that is, methods for identifying Map regions useful for Target Selection. Frequently it will be used to prepare and conduct: drug target discovery, drug repositioning, drug combination, adverse event prediction, identification of biomarkers for diagnostic kits and the similar. Multifocal Strategy increases the chances of finding a relationship between two regions over the Map (Input-Out), due to the fact that more nodes are involved.
Mechanism of action discovery, that is, methods for determining the mechanism of action of a drug or a physiological effect.

Topological Analysis

This analysis will allow extracting all possible information from the structure of the Map, according with properties of nodes and links or by inference of these properties. The present application provides novel systems and methods to conservatively transform of the Map preserving its properties and capabilities.

One of the steps of the present application provides novel mathematical transformations of the Map by using mathematical methods not applied to biological maps in prior art.

The Map has the following constraints and characteristics:
In a preferred embodiment the Map has been created using the described strategy in this document but any other type of Map could be used in this analysis.
A majority of the nodes and links must be related with their corresponding

Biological Element, or at least, most of them must keep a relationship with some corresponding Biological Function.
When nodes and links don't have any known correspondence between them and a Biological Element or Function these properties will be inferred from the map. So the content of the Map is only an estimation of the real Map occurring in nature, and all these elements must be taken into account in the analysis. The method of analysis will be flexible enough to treat this lack of information without disturbing the final conclusions extracted from the analysis.

Dimensional Reduction of the Map

The number of dimensions of a Map corresponds to the number of nodes that belong to it, frequently in the order of thousands.

If the number of dimensions is high (typically more than 3), it is possible that the results of the analysis of the map cannot be easily understood by the end user, and the conclusions cannot be applied easily to explain observable facts of the nature, usually measurable phenotype effects.

The number of dimensions that a given analyst can manage to conduct visual analysis is 2 or 3 dimensions (2D or 3D). In a preferred embodiment 3 will be the number of maximum of dimensions used to perform visual analysis but any other number of dimensions can be obtained being also useful to extract information.

In a preferred embodiment the methods to reduce the number of dimensions will preserve the maximum quantity of the information of the system after the reduction of dimensions.

In a preferred embodiment the methods to perform the dimensional reduction that can be applied belong to the group, but are not limited to: PCA (Principal Component Analysis), MDS (MultiDimensional Scaling), ICA (Independent Component Analysis), Fisher LDA, NMF (Non Negative Matrix Factorization), Non linear PCA and Projection Pursuit, Khonen Maps, ISOMap, and any variation, combination or equivalent approach. In another preferred embodiment, any other method to reduce dimensions of a system can be used.

By applying the methods of dimensional reduction, a new system in 2D or 3D will be obtained. This new system can be represented as a picture in a screen or a paper to be used by analysts.

In a preferred embodiment, 2D and 3D transformations will minimize the distance of representation of two nodes when any measurable relationship or property between these two nodes exists. Consequently, the distance of two nodes with exactly the same properties will be zero and it will be distance maxim if these two nodes are absolutely different in terms of the measurable property used in this analysis.

One of the steps of the present application not identified in the prior art identifies several methods for reduction of dimensions of the system, which are useful to extract conclusions and to understand any result.

Motives with Biological Relevance Identified in Regions of the Map or in its Transformations

The present application provides methods for identification of patterns over the map or over any transformation of the map, which will be used to relate nodes, links or group of nodes of the map with any measurable physiological effect.

The construction of these clusters is a part of the Multifocal Targeting Strategy.

In a preferred embodiment any property of nodes or links, any pattern of connection between them, function, or any biological attribute of them, including their relative position in the map or in any transformation applied over the map, will be used to identify clusters of nodes. Any clustering technique such as, but not limited to, hierarchy techniques, optimization and partitioning techniques, density searching strategies, grouping techniques, agglomerative techniques, artificial neural networks or any other strategy that can be used as a preferred embodiment to obtain clusters.

Roles, functions and properties will be assigned to these clusters taking into account the roles, functions and properties of nodes and links contained in the clusters even when this knowledge it was unknown for a specific node or link by inferring the information from their neighboring.

Clusters can be obtained with an enrichment of any property conferring to this cluster and nodes and links belonging to it a putative measurable physiological effect (Output), or a point as Input signals. This strategy is the core of the Multifocal Targeting Strategy, by which not only a node is defined as being of biological interest, but a group of nodes, usually all of them members of the cluster.

One of the steps of the present application provide novel processes by which novel roles, functions and properties can be assigned to nodes or links that have not been previously defined for them.

One of the steps of the present application provides that the Multifocal Strategy is defined from the Topological Analysis of the map.

The Mathematical Modeling of the Map

In a preferred embodiment the mathematical modeling of the system will describe all the mathematical functions associated to nodes and links.

The present application provides novel methods and systems that will allow to those skilled in the art:

To identify certain nodes or links with special relevance, as in the described method of Target Selection.

To identify certain regions with indirect relationship with Target Selection, as described in Multifocal Targeting Strategy.

To describe previously unknown mechanisms of action, or in other words, to establish the existing relationship between nodes of the map.

In a preferred embodiment the objective of any model will be predicting the values contained in True-Tables.

In a preferred embodiment the mathematical model of the map will be conducted by means of rules, any type of artificial intelligence learning process, supervised or not (see for example Bishop, C. M. (1995). Neural Networks for Pattern Recognition, Oxford University Press. ISBN 0-19-853864-2), genetic algorithms, artificial neural networks of any type and variant or stochastic methods like Simulated Annealing, Montecarlo or whatever similar method known. All this techniques can be used to determine functions associated to links, nodes or group of them or the parameters of these functions.

Each type of methods will have associated their own parameters and characteristics. For instance, genetic algorithms will have associated artificial chromosomes, being each chromosome a model of the map. In a preferred embodiment, the values for functions and parameters are initially randomized over a Gaussian distribution. In this case, a surviving function for chromosomes will be executed to decide which chromosome (model) represents the best mathematical model to explain the True-Tables. Mathematical functions for mutations and re-combinations over these chromosomes will be applied to select the model to better fit and explain the True-Tables, and in consequence to better fit and explain the nature.

Step 3: Performing Experimental Validation of the Mathematical Models

In a preferred embodiment the signals are transmitted over the map or any transformation of it. These signals are treated as Inputs and Outputs, as per the definition previously given. All these signals are stored in True-Tables.

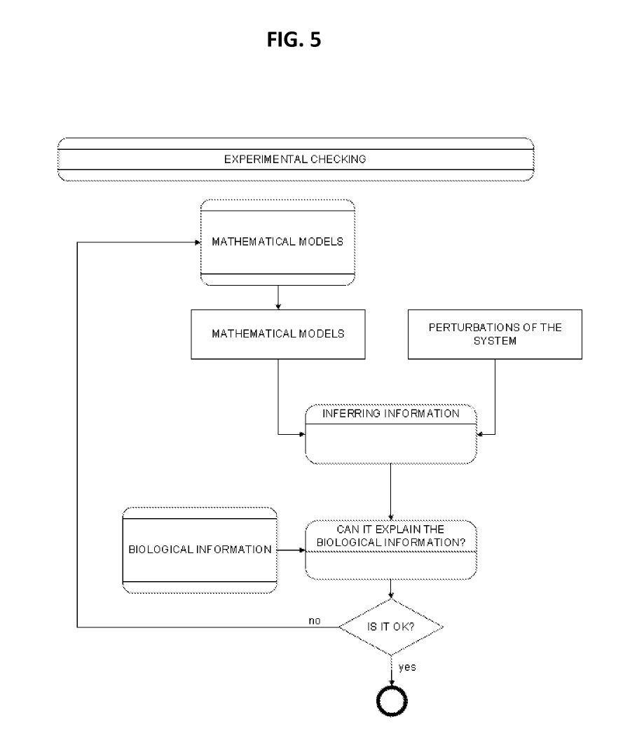

In a preferred embodiment the mathematical model is created to explain known cases of inputs and outputs using any kind of strategy as described above and in FIG. 5.

One of the steps of the present application provides methods for constructing True-Tables that represent the mathematical values of nature, and that are used to train and/or to check the validity of any mathematical model created.

In a preferred embodiment the selection of the model will prioritize the capability of the mathematical model proposed to explain those biological effects that are the objective of the analysis.

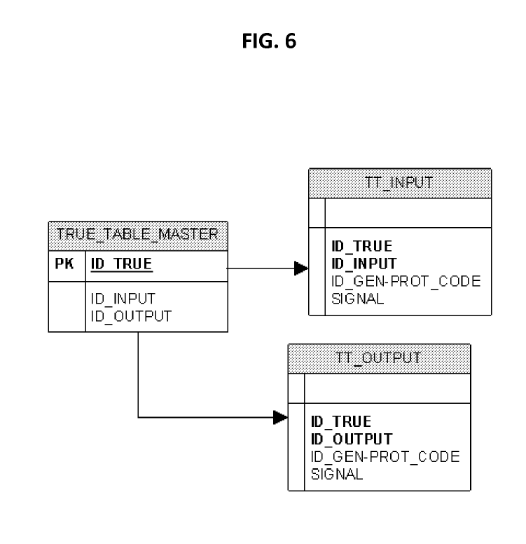

In a preferred embodiment the evaluation of the model will be executed by checking the capability of the model to explain known biological effects, usually those biological effects contained in the True-Table, or the True-Table itself. FIG. 6 shows an example of the structure of the True-Tables used to put into practice the current methods.

One of the steps of the present application provides methods by which a plurality of models can be used simultaneously by means of the construction of a supra-model, or a model containing other models within it, in order to better explain the True-Tables. A supra-model is defined as a more general model that contains as components constitutive models that for example explain certain regions of the map, but not others. Thus the supra-model can be considered an ensemble of smaller models that explains the whole network.

Inferring Information from the Model

The obtained final model according to the description of the present application has a set of applications in different fields related with health (human and veterinary), food, and cosmetic applications, but also for related and more general fields like biochemistry, physiology, psychology, biology, medicine and the similar.

The present application defines three main methods to analyzing the models: Target Selection, Multifocal Targeting Strategy or Mechanism of action.

Target Selection Method

According to the present application, the use of Target Selection Method allows determining nodes in the map with especial interest, either because it is an interesting point to introduce an Input signal (Target node) or because it is a interesting point to measure the Output signal (usually an Effector).

Frequently, Target Selection is used by the end user of the present application to prepare and conduct drug target discovery, drug repositioning, drug combination, adverse event prediction, identification of biomarkers for diagnostic kits and the similar.

In a preferred embodiment the Target Selection is done from analysis of clustering and performed over the map or any transformation of it from the Topology, Functional or Biological point of view but any clustering criteria could be applied.

In another preferred embodiment any node will be evaluated in the model as a possible Target node.

Target nodes are used for a plurality of utilities depending of the map and of the use of it. Uses of Target nodes can be selected from the following list, for instance, but are not limited to:
1) A Target Node as provided in the present application, is a target protein useful in the process to develop new drugs, or in the same sense, genes or any intermediate product between genes and proteins or any derived product of the activity of this target protein, gene or the similar.
2) A Target Node as provided in the present application, is a target protein useful to treat a pathology not previously related with this target protein, or in the same sense, genes or any intermediate product between genes and proteins or any derived product of the activity of this target protein, gene or the similar.
3) A Target Node as provided in the present application is a biomarker. According to the usual definition, a biomarker is a protein useful to be measured and whose presence and/or quantity is related with any metabolic state, especially those metabolic states related with pathologic processes. In the same sense, it can be applicable to genes or any intermediate product between genes and proteins or any derived product of the activity of this target protein, gene or the similar.
4) A Target Node as provided in the present application comprises in general any biological element or process useful to obtain knowledge about the consequences of the activation or inhibition of a biological element, preferably but not limited to proteins or genes.

One of the steps of the present application provides mathematical methods useful to discover new target nodes. These methods are applied to discover target proteins or genes useful to develop new drugs or to develop diagnostic kits in the health care area. These methods are also useful to develop detecting kits in any other field related to biotechnological approaches.

Multifocal Targeting Strategy

This method allows identifying Map regions where all included nodes and links in these regions produce a similar or cooperative Biological Effect, being Input signals (Target nodes) or Output Signals (Effectors). This fact allows selecting more than one node to develop a specific work, increasing the number of possibilities of success and decreasing the negative consequences produced by a specific perturbation over a point of the map (activation or inhibition).

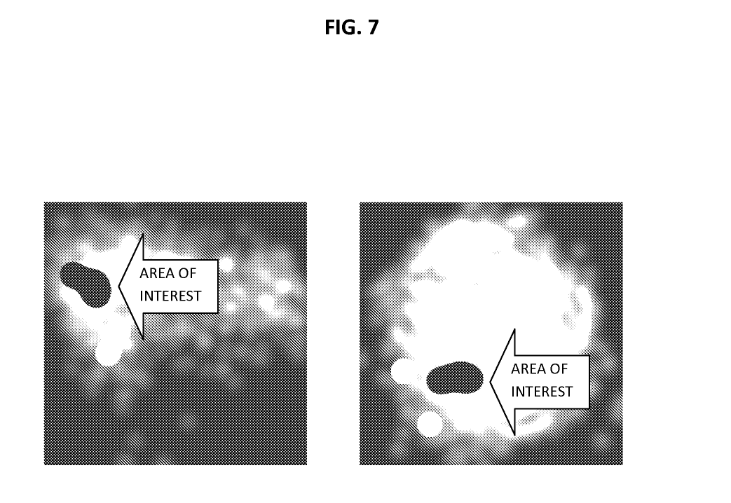

In a preferred embodiment the Multifocal Targeting Strategy is based on the clustering analysis of the map (topological, functional, biological or whatever other strategy). By this novel method of the present application, some regions of the map and some nodes belonging to these regions will used to introduce Input signals or measure Output signals in the map. An example of how those regions are located in the map is shown in FIG. 7.

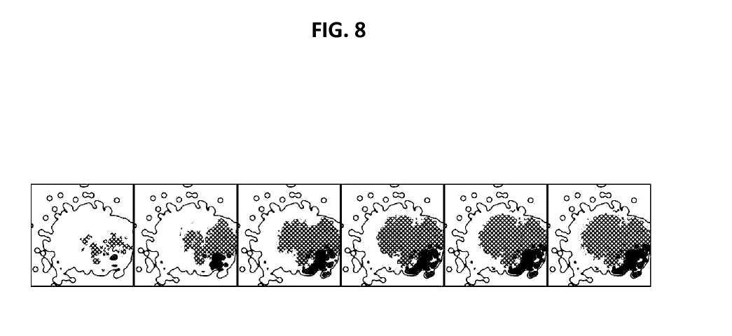

One of the steps of the present application provides novel methods by which, instead of having a simply Target node or single Effector, the method provides a strategy to discover more than one node that produces the effect under study. In the drug discovery process, for instance, the method provides a way to reduce the activities of the drugs because if more than a target exists, the concentration of a specific drug can be lower, thus decreasing both the toxicity and of course functional activity. However, the decreasing of functional activity can be supplied developing new drugs against other targets but with the same functional activity, thus having a synergistic effect. In a kit design, the methods provided will allow to identify simultaneously several markers at the same time, increasing the usefulness of the kit due to the synergistic effect of the combination. FIG. 8 shows how a certain complex signal exerting different output results (activation or inhibition) over certain groups of proteins is transmitted across the map.

Determination of the Mechanism of Action

As used herein, “mechanism of action” means the relationship between nodes, links and group of them that they are representing Biological Elements and measured as points for Input signals and/or for Output Signals. All these elements are treated as functions explained over the global model.

This determination can be done even when the knowledge about a node or a link is very low or even links and/or the Biological Elements corresponding to these nodes or links are not known.

One of the steps of the present application provides methods that allow determining the mechanism of action of a given biological process. Typically, the human biological processes are complex enough to be unknown in complete detail. The use and analysis of the map as it is described in the present application allows the end user to understand globally the system when a particular experimental analysis is not feasible.

In another aspect of the present application, the present application provides nucleic acid vectors codifying biological elements of interest identified by using the methods and systems of the present application.

In another aspect of the present application, the present application provides a cell containing the vectors mentioned herein.

In still another aspect of the present application, the present application provides methods and kits to detect the presence of any of the biological elements of interest identified by using the methods and systems of the present application in any biological fluid.

In still another aspect of the present application, the present application provides methods to modulate, inhibit, activate, suppress, enhance or modify the activity of the biological elements of interest identified by using the methods and systems of the present application in the body of an animal, specifically of a human being.

In still another aspect of the present application, the present application provides a molecule or molecules or a substance or substances of any type that bind with certain specificity to any of the biological elements of interest identified by using the methods and systems of the present application.

In still another aspect of the present application, the present application provides a molecule or molecules or a substance or substances with a certain topology and surface components, like hydrophobic or hydrophilic moieties, cationic or anionic moieties, or any other topological or superficial characteristics, contributing such characteristics to the binding of the molecule to a given biological element of interest identified by the methods herein, specifically to direct or indirect therapeutic targets, direct or indirect adverse events effectors, disease biomarkers, genetic biomarkers, safety-related biomarkers, diagnostic molecules, hormones, metabolites, metabolic effectors of any type, and the similar.

In still another aspect of the present application, such molecule or molecules or a substance or substances identified by using the methods herein are capable of binding simultaneously to more than one biological element of interest as described in the animal body, specifically in the human body.

In still another aspect of the present application, such molecules or a substance or substances provided by the present application modulate the activity of one or several biological elements of interest in such a way that those molecules can be used as therapeutic treatments for a disease or condition, as modulators of a disease or condition, as biomarkers of a disease or condition, or as triggers of a disease or condition.

In still another aspect of the present application, the present application provides methods for identifying a plurality of biological elements or processes of biological interest (for example, a plurality of protein targets), that can be modulated simultaneously, in a fully new manner not described in prior art, thus leading to the modulation of a process of biological interest occurring inside the human or animal body that can lead to a disease cure, that can be related with a drug safety related process, that can be related with a biomarker process, that can be related to a diagnostic process, that can be related to the knowledge of a biological mechanism of action, and the similar.

In still another aspect of the present application, the present application provides a plurality of molecules or substances that, when used in combination to modulate the activity of a set of targets, can lead to the modulation of a process of biological interest, like for example curing a disease.

In still another aspect of the present application, the elements of biological interest mentioned can be uniquely identified. In still another aspect of the present application the elements of biological interest can be identified in a broader way as having the property to belong to certain regions of the map which show to be of relevance for the process of biological interest (for example, curing a disease).

Thus, in certain forms of the present application, the present application provides regions of the biological map which are of biological interest, being those regions composed by a plurality of biological elements that can be of the same nature (for example proteins), or of diverse nature, like for example nucleic acids, small molecules, metabolites, lipids, carbohydrates, salts and ions, or proteins.

In still another aspect of the present application, the molecule or molecules or substance or substances can be identified as having the property to being able to bind or modulate regions of the map, and in still another aspect of the present application, the molecules or molecules or substance or substances can further used as modulators of such regions of the map, like for example for curing a disease.

### EXAMPLES

### Example 1

### Evaluation the Therapeutic Performance of Diazepam in Terms of New Indications and Safety Profile, by Using the Methods of the Present Application

The following example depicts a situation where the end user may want to analyze a given drug or combination of drugs in terms of new indications (reprofiling), and safety profile of the compound.

Diazepam DCI (known commercially under several brands, for example “Valium”), is used in the treatment of severe anxiety disorders, as a hypnotic in the short-term management of insomnia, as a sedative, as an anticonvulsant, and in the management of alcohol withdrawal syndrome. Diazepam binds to GABA_{A} (gamma-aminobuytric acid) receptors in the central nervous system (CNS), thus causing CNS depression, and preventing excitability of dopaminergic and noradrenergic system.

The three seed proteins currently known as direct diazepam targets were used as seed nodes for constructing the Map: gamma-aminobutyric-acid receptor subunit alpha-1, gamma-aminobutyric-acid receptor subunit alpha-3, and translocator protein. The Map was extended by the methods described above, including literature search, Drugbank database, and INTACT database. The final Map thus obtained contained 391 nodes. All known effects (indications and frequent adverse events) of this drug can be explained by means of a topological analysis. The indications and the most frequent adverse events are behavior disorders (proteins with PDB code P14867, P35462, among others), nervous system diseases (PDB codes P04156, among others). sensation disorders (PDB codes A5X5Y0, P07550, among others), digestive disorders (PDB codes P08172, P20366, among others) and neurologic manifestations (PDB codes P35462, among others).

Table 1 depicts the main known indications of Diazepam, and the Haussdorf distance from the diazepam protein targets (seed nodes), to the protein molecular effectors in the Map. Hausdorff distance expresses the mean distance between a group of nodes to a certain other group of nodes, expressed in the number of “jumps” between them, being 0=identity, 1=2 proteins in direct contact, or one jump, 3=2 proteins with a node between them, or 2 jumps, and so on.

TABLE 1
Hausdorff distance between Diazepam targets (seed
nodes) and proteins related with molecular mechanisms
of certain therapeutic indications of Diazepam

| Main Indications | Hausdorff distance |
|---|---|
| Insomnia | 0.5 |
| Panic disorder | 0.5 |
| Anxiety | 0.74 |
| Alcohol withdrawal | 1.08 |
| syndrome | |

Other less common indications were also identified in the map by means of Hausdorff distances.

TABLE 2
Other possible indications of Diazepam,
according to Hausdorff distances

| Other Indications | Hausdorff distance | References |
|---|---|---|
| Neurodegenerative | 1.25 | Naubach. K (2003). Curr |
| disorders | | Drug Targets CNS Neurol |
| | | Disord. 2 (4): 233-9 |
| Rheumatic | 1.28 | Tarpley. E. (1965). |
| disorders | | Journal of chronic disease. |
| | | 18: 99-106 |
| Pain | 2.08 | Chapman CR (1973). |
| | | Psychosomatic medicine. |
| | | 35: 330-340 |
| Schizophrenia | 2.10 | Beckmann. H. et. al. |
| | | Psychopharmacology. |
| | | (71) 79-82 |
| Epilepsy | 2.17 | Wermeling D. P. (2009). |
| | | Neurotherapeutic 2: 381-2 |

Main adverse events for Diazepam were also correctly identified

TABLE 3
Main Adverse Events (AES) of Diazepam

| Main AES | Hausdorff distance |
|---|---|
| Dizziness | 1.33 |
| Tremor | 1.58 |
| Fatigue | 1.79 |
| Nausea | 2.23 |

Other less common adverse events of Diazepam were correctly identified

TABLE 4
Other adverse events related with Diazepam

| AES | Hausdorff distance |
|---|---|
| Hiccup | 1.54 |
| Arthralgia | 1.72 |
| Headache | 1.75 |
| Appetite disturbance | 1.78 |

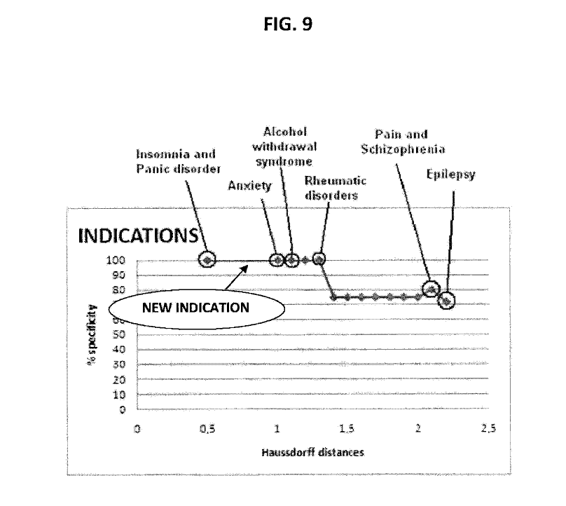

FIG. 9 shows all known indications for Diazepam, and identifies one previously unknown possible indication (arrow), with a 100% specificity. Other indications can also be hypothesized with a sensitivity of over 70%.

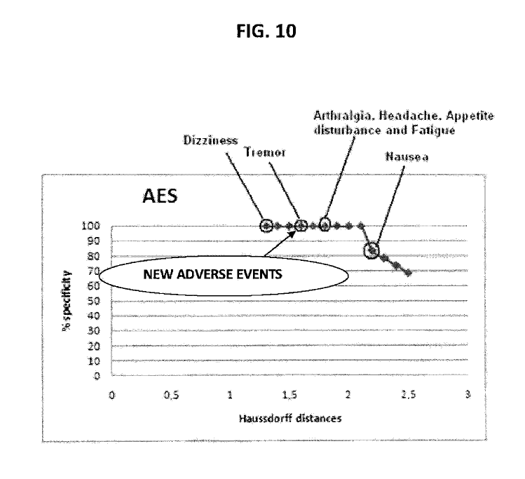

FIG. 10 shows all described adverse events for Diazepam, and identifies other previously not described potential adverse events.

The example above shows that the methods and systems of the present application are able to identify indications and adverse events profile of drugs intended for pharmaceutical use, being thus a new and powerful tool for increasing efficiency of pharmaceutical research and development, among other applications.

### Example 2

### Safety Profile of a Drug Based on the Topological Analysis

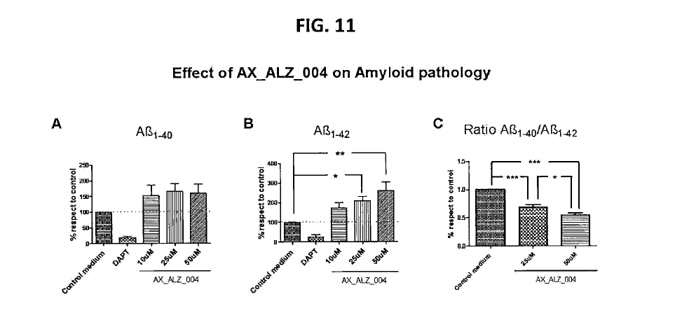

AX_ALZ_{—}004 is a commercialized drug used to treat gastrointestinal disorders, with a known safety and efficacy profile for a number of indications. The safety profile of the drug AX_ALZ_{—}004 has been created by means of the use of the topological analysis described in the present application. In order to evaluate the results of the methods of the present application, these results have been experimentally checked. The known protein targets of the drug AX_ALZ_{—}004 where obtained from literature and public databases as described, and they were used as seed nodes to create a map. The map was composed of a total of 2.537 nodes and 30.040 links. The map contains nodes (individual specific proteins) that act as molecular effectors for indications and for known frequent adverse events of the compound AX_ALZ_{—}004 such as headache, gastrointestinal disorders, diarrhea, and skin rashes. The distance of the effectors of these motives and the seed nodes measured by means of the Hausdorff's distance's definition and estimated to be under 2.3 jumps. Some unexpected effectors related with safety problems were detected under the distance of 2.3 between them and the seed nodes. These effectors newly discovered were related to amyloid pathology, and specifically predicted an increase of beta amyloid proteins as a consequence of the intake of the drug. These effectors were not described in any prior art for this drug and neither for its targets. This fact is a relevant safety issue that could be especially relevant for patients suffering the Alzheimer's disease. To confirm the putative safety problems of this drug we conducted Aβ₁₋₄₀ and Aβ₁₋₄₂ Elisa assay on the extracellular media of treated and untreated cells stably expressing wild-type presenilin-1 an Aβ precursor protein. FIG. 11 shows how amyloid results obtained experimentally confirm our theoretical predictions obtained by means of the methods described herein.

### Example 3

### Designing a Treatment for Alzheimer's Disease Based on the Multifocal Targeting Strategy

Alzheimer's disease is a multifactorial pathology. Its main causative factors can be grouped in four distinct molecular motives: amyloid pathology (involving for example proteins with PDB codes P05067, P49768 and others), tau pathology (PDB codes P10636, P49841, and others), oxidative stress (PDB codes P07203, P04839, and others), and neuronal dysfunction and cell death (PDB codes Q07812, P55211 and others).

These effectors were used as seed nodes or seed proteins to create the map of the pathology, and to obtain a complete map of the Alzheimer's disease. Drug targets in the map, within a Hausdorff distance from seed nodes of less than 3, were identified without prior knowledge in the treatment for central nervous system diseases. A final group of target candidates was obtained by means of using the closest distances between the targets and the seed nodes, and by using the topological relationship between these target candidates in front to known drug targets for Alzheimer's disease. The drugs that modulate the target candidates so identified were defined as putative candidates to be a new treatment for the Alzheimer's disease. The final accepted candidates were assigned a putative relationship with a defined motive for the Alzheimer's disease, on behalf of their topological position in the map in respect to the described causative motives. In this manner, the relation with amyloid pathology was predicted for AX_ALZ_{—}003, AX_ALZ_{—}004, AX_ALZ_{—}007, the relation with tau pathology was assigned to AX_ALZ_{—}002; the relation with oxidative stress was determined for AX_ALZ_{—}004, AX_ALZ_{—}006, AX_ALZ_{—}007; and the relation with neuronal dysfunction and cell death was predicted for AX_ALZ_{—}003, AX_ALZ_{—}004, AX_ALZ_{—}006. To evaluate amyloid pathology, Aβ₁₋₄₀ and Aβ₁₋₄₂, ELISA assays on the extracellular media of treated and untreated cells stably expressing wild-type presenilin-1 and amyloid precursor protein were conducted. Tau pathology was evaluated on tau-transfected in a mouse hippocampal-derived HT4 cell line using a phospho-tau and Tau ELISA assay. Antioxidant effect of the following drugs against oxidative stress stimulus and cell viability assays were evaluated using ToxiLight Non-Destructive Cytotoxicity BioAssay kit on a mouse hippocampal-derived HT4 cell line.

Potential drug effect on neuronal dysfunction was studied using Amplex Red Acetylcholine/Acetylcholinesterase Assay Kit. Results are shown in Table 5 below. This table establishes a positive relationship between the predictions and the results obtained experimentally. The results show that 77.8% of the predictions according to the methods of the invention were confirmed experimentally.

Multifocal Targeting Strategy is applied from the results showed in Table 5, and adding the information between distances of effectors of the four motives and the targets of selected drugs. The best drug combinations are those that maximize the activity in the four motives at the same time. One example of good drug combination to treat the Alzheimer's disease could be a combination of AX_ALZ_{—}002 and AX_ALZ_{—}006.

TABLE 5
Experimental effect of potential drug candidates on the respective
predicted molecular causative motive of Alzheimer Disease

| | Predicted Motive | | | |
|---|---|---|---|---|
| | Amyloid | | | Dysfunction |
| | pathology | Tau | Oxidative | and cell |
| DRUG CODE | (neuronal) | pathology | stress | death |
| AX_ALZ_002 | | ACTIVE | | |
| AX_ALZ_003 | NOT | | | ACTIVE |
| | ACTIVE | | | |
| AX_ALZ_004 | ACTIVE | | NOT | |
| | | | ACTIVE | |
| AX_ALZ_005 | | | | |
| AX_ALZ_006 | ACTIVE | | ACTIVE | ACTIVE |
| AX_ALZ_007 | | | ACTIVE | |

Other embodiments of the present application will be apparent to those skilled in the art from consideration of the specification and practice of the present application disclosed herein. It is intended that the specification and examples be considered as exemplary only, with a true scope and spirit of the present application being indicated by the following claims.

What is claimed is:

1. A method for identifying molecules and processes of biological interest, comprising:
a) creating a map of biological elements, comprising the following steps:
identifying seed nodes, adding related nodes, linking the seed nodes and the related nodes, optionally adding artificial nodes, adding artificial links between the artificial nodes or between the artificial nodes, the related nodes, and the seed nodes, optionally aggregating the seed nodes, the related nodes, and/or artificial nodes, and optionally pruning the seed nodes, the related nodes, and/or artificial nodes, wherein each step is performed according to information from biological databases;
b) developing a mathematical model based on the map of biological elements, using one or several of the following processes: genetic algorithm parameterization, stochastic parameterization, analytical parameterization, and model validation;
c) performing experimental checking and validation of the mathematical model obtained in b), comprising the following steps: perturbing the mathematical model, inferring information from the perturbed models, and validating the inferred information by comparing the information to known biological empirical data;
d) identifying elements or processes of biological interest using the information inferred from the validated mathematical model; and
e) producing a representation containing the identified biological elements or processes.

2. The method of claim 1, wherein the nodes comprise molecules existing in the human or animal body or bacteria or virus including proteins, polypeptides, polynucleotides of any type, hormones of any type, genes, metabolites, signaling molecules, aminoacids, neurotransmitters, and the similar, alone or in any combination.

3. The method of claim 1 wherein the links are mathematical functions that describe the biological relationships between the nodes.

4. The method of claim 1, wherein the biological databases used in creating the map comprise public or private databases containing information about biological elements.

5. The method of claim 1, wherein the molecules of biological interest include direct or indirect therapeutic targets and the molecules that modulate their behavior, direct or indirect adverse events effectors, disease biomarkers, genetic biomarkers, safety-related biomarkers, diagnostic molecules, hormones, or metabolites of any type.

6. The method of claim 1, wherein the processes of biological interest are any biological process occurring inside the human or animal body that can lead to a disease cure, that can be related with a drug safety related process, that can be related with a biomarker process, that can be related to a diagnostic process, or that can be related to the knowledge of a biological mechanism of action.

7. The method of claim 1, wherein regions of the biological map which are of biological interest are identified, those regions composed of a plurality of biological elements of a same nature or different natures, selected from nucleic acids, small molecules, metabolites, lipids, carbohydrates, salts and ions, and proteins.

8. The method of claim 1, wherein a plurality of mathematical analyses are used to maximize a predictive value of the mathematical model.

9. The method of claim 1, wherein the predictive value is checked against true-tables containing known biological data.

10. The method according to claim 1, wherein the molecules of biological interest are a combination of molecules.

11. The method according to claim 1, wherein the processes of biological interest are a combination of processes.

12. A method according to claim 1, wherein the method is used for identifying a plurality of biological elements or processes of biological interest that can be modulated simultaneously inside human or animal body, wherein the modulation of the processes related to a disease cure, a drug safety related process, a biomarker process, a diagnostic process, or accumulation of knowledge of a biological mechanism of action.

13. A method for identifying therapeutic targets for diseases, comprising the steps a), b), and c) of claim 1.

14. A method for identifying drug candidates, comprising the steps a), b), and c) of claim 1.

15. A method for identifying a compound or compounds for cosmetics, nutraceutics, or veterinarian uses, comprising the steps a) to e) of claim 1.

16. A method for identifying potential adverse events of a drug or group of drugs, comprising the steps a) to e) of claim 1.

17. A method for identifying a biomarker or biomarkers to identify individuals with a certain condition, or a predisposition to the certain condition, comprising the steps a) to e) of claim 1.

18. A method for identifying a use for a known therapy, comprising the steps a), b), and c) of claim 1, comprising the steps a) to e) of claim 1.

19. A method for prioritizing molecule candidates for further drug development, comprising the steps a) to e) of claim 1.

20. A method of conducting business services, comprising:
applying the method and system according to claim 1 or 21 to identify and characterize a biological element or a biological process of interest for a costumer; and
receiving compensation from the customer in return for providing identification and/or characterization of the biological elements or processes, wherein the services include identification and/or characterization of the biological elements or processes related to discovery, efficacy, safety, sensitivity, and a combination thereof.

21. A system, comprising:
a computer-readable medium;
at least one processor coupled to the computer-readable medium; and
at least one human-readable output coupled to the computer readable medium and the processor system;
wherein the system is capable of executing the method of claim 1 in a specified manner, comprising a database module creating and storing databases of biological data, a first unit operations module transforming the databases into biological maps, a second unit operations module generating at least one mathematical model, an analysis module executing experimental analysis and processes, and a comparison module comparing results arising from the models to at least a first set of empirical data.

22. A nucleic acid vector codifying biological elements of interest identified by using the method of claim 1.

23. A cell containing the vectors of claim 22.

24. An apparatus for detecting presence of any of the biological elements of interest identified by using the method of claim 1 in any biological fluid.

25. A method for modulating, inhibiting, activating, suppressing, enhancing or modifying the activity of the biological elements of interest identified by using the method of claim 1 in an animal body or a human body

26. A molecule, substance, or a pharmaceutical composition containing molecules or substances that bind with certain specificity to any of the biological elements of interest identified by using the methods of claim 1.

27. A molecule or molecules or a substance or substances with a certain topology and surface components, like hydrophobic or hydrophilic moieties, cationic or anionic moieties, or any other topological or superficial characteristics, or a pharmaceutical composition containing thereof, contributing such characteristics to the binding of the molecule to a given biological element of interest, identified by the methods of claim 1, specifically to direct or indirect therapeutic targets, direct or indirect adverse events effectors, disease biomarkers, genetic biomarkers, safety-related biomarkers, diagnostic molecules, hormones, metabolites, metabolic effectors of any type, and the similar.

28. A molecule or substance according to claim 27 capable of binding simultaneously to more than one biological element of interest in the animal body, specifically in the human body.

29. A molecule or substance according to claim 27 or pharmaceutical composition containing such that modulates the activity of one or several biological elements of interest in such a way that those molecules can be used as therapeutic treatments for a disease or condition, as modulators of a disease or condition, as biomarkers of a disease or condition, or as triggers of a disease or condition.
